(19) United States
(12) Patent Application Publication
(10) Pub. No.: US 2012/0272308 A1
(43) Pub. Date: Oct. 25, 2012

(54) MANAGEMENT SYSTEM, MANAGEMENT METHOD AND MANAGEMENT PROGRAM FOR MANAGING INDUSTRIAL CONTROL SYSTEM

(75) Inventors: Takuya Mishina, Kanagawa-ken (JP); Tadashi Tsumura, Kanagawa-ken (JP); John David Wilson, Houston, TX (US)

(73) Assignee: International Business Machines Corporation, Armonk, NY (US)

(21) Appl. No.: 13/443,083

(22) Filed: Apr. 10, 2012

(30) Foreign Application Priority Data
Apr. 22, 2011 (JP) 2011-095807

(51) Int. Cl. G06F 21/00

(52) U.S. Cl. 726/11

(57) ABSTRACT

A system and method of an appropriate countermeasure at the time of anomaly. The management system for an industrial control system includes a control apparatus, a control network connected to the control apparatus, and multiple devices controlled by the control apparatus via the control network, the management system includes multiple firewall modules provided for each of control zones each controlling one part of the industrial control system, the firewall modules relaying communication between devices in the control zones and the control network; an event analyzing module collecting events from each of the multiple firewall modules and analyzing the events to detect an anomaly of each of the control zones, and a communication managing module changing a communication operation performed via the firewall module provided for the control zone where an anomaly has been detected.

### CROSS-REFERENCE TO RELATED APPLICATION

This application claims priority under 35 U.S.C. §119 from Japanese Patent Application No. 2011-095807 filed Apr. 22, 2011, the entire contents of which are incorporated herein by reference.

### BACKGROUND OF THE INVENTION

1. Field of the Invention

The present invention relates to a management system, a management method, and a management program for managing an industrial control system.

2. Description of Related Art

Industrial control systems (ICS) for managing and controlling industrial and infrastructure systems are known. A multitude of conventional industrial control systems operate with specific protocols without being connected to external networks. In recent years, industrial control systems have been interconnected with general protocols such as the Internet Protocol, and a growing number of systems are connected with external networks.

When connected to an external network, an industrial control system will have more threat of external attacks. Therefore, such an industrial control system is required to execute a countermeasure process when an anomaly occurs in a device or the like incorporated therein.

Such industrial control systems, however, include both those in which a countermeasure process must be reliably executed, and those in which the influence of the execution of a countermeasure process on other systems must be minimized. Therefore, in industrial control systems, it has been necessary to reliably execute an appropriate countermeasure process upon occurrence of anomaly.

### SUMMARY OF INVENTION

In a first aspect of the invention, a management system for an industrial control system is provided. The industrial control system includes a control apparatus, a control network connected to the control apparatus, and multiple devices controlled by the control apparatus via the control network. The management system includes multiple firewall modules provided for each of control zones each controlling one part of the industrial control system, the firewall modules relaying communication between devices in the control zones and the control network, an event analyzing module collecting events from each of the multiple firewall modules and analyzing the events to detect an anomaly of each of the control zones, and a communication managing module changing a communication operation performed via the firewall module provided for the control zone where an anomaly has been detected.

In a second aspect of the invention, an industrial control system is provided. The industrial control system includes a control apparatus, a control network connected to the control apparatus, multiple devices that are controlled by the control apparatus via the control network, multiple firewall modules provided for each of control zones including each part of the multiple devices, the multiple firewall modules relaying the communication between the devices in the control zones and the control network, an event analyzing module collecting events that occur in the multiple firewall modules and analyzing the events to detect an anomaly of each of the control zones and a communication managing module changing communication operation via a firewall module provided in the control zone where an anomaly has been detected.

In a third aspect of the invention, a management method for managing an industrial control system including a control apparatus, a control network connected to the control apparatus, multiple devices controlled by the control apparatus via the control network, and multiple firewall modules provided for each of control zones that controls each part of the multiple devices is provided. The method includes relaying the communication between the devices in the control zones and the control network by the multiple firewall modules, collecting events that occur in the multiple firewalls and analyzing the events to detect an anomaly of each of the control zones, by a computer, and changing the communication operation via the firewall module provided in the control zone where an anomaly has been detected, by the computer.

Also provided is a non-transitory computer readable storage medium tangibly embodying a computer readable program code having computer readable instructions which, when implemented, cause a computer to carry out the steps of the above method of managing an industrial control system.

### BRIEF DESCRIPTION OF DRAWINGS

FIG. 1 shows the configuration of a computing system relating to the present embodiment;

FIG. 2 shows an example of a state workflow and anomaly detection condition;

FIG. 3 shows the configuration of a data center system relating to a variant of the present embodiment;

FIG. 4 shows an example of the process flow at the time of temperature anomaly of a data center system;

FIG. 5 shows an example of a countermeasure flow in the data center system;

and

FIG. 6 shows an example of the hardware configuration of a computer relating to the present embodiment.

### DETAILED DESCRIPTION OF THE PREFERRED EMBODIMENTS

While the present invention is described with reference to the embodiments, it should not be viewed as being limited thereto. Thus, combinations and sub-combinations thereof are also contemplated by the present invention.

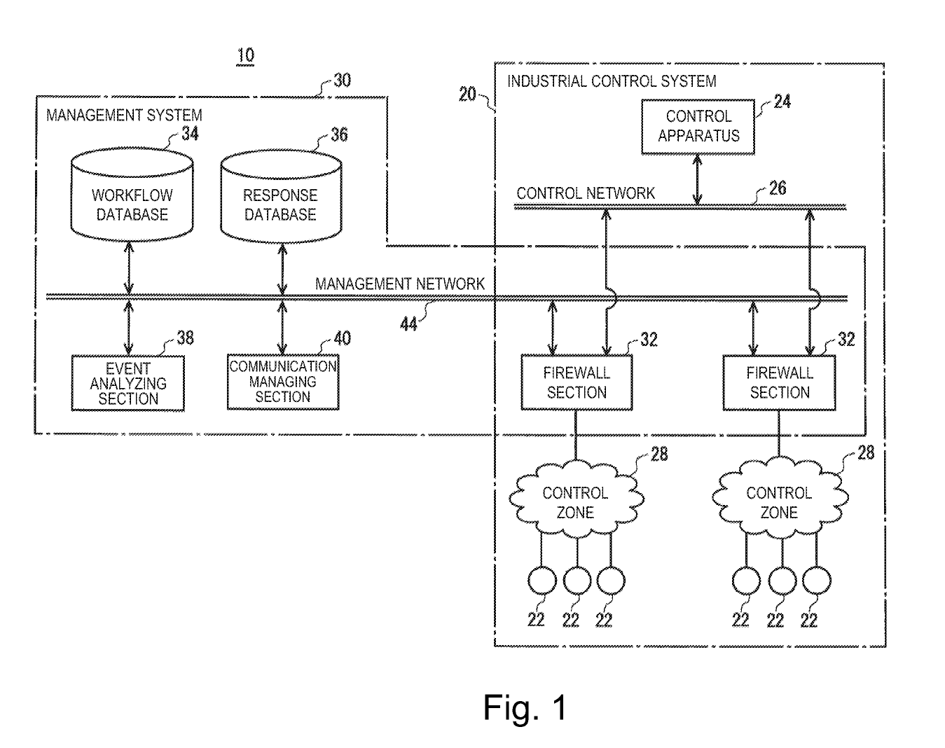

FIG. 1 shows the configuration of a computing system 10 relating to the present embodiment. The computing system 10 relating to the present embodiment includes an industrial control system 20 and a management system 30. The industrial control system 20 is a system that is connected with multiple computers and multiple devices, etc. The industrial control system 20 is, for example, a system that performs management and control of each object of industrial manufacturing systems, infrastructure (transportation and energy etc.) systems, and the like.

The industrial control system 20 can be a system that manages various devices (for example, power supply, utility gas, water supply, air conditioning and security systems, and so on) connected to the network in a building. Moreover, the industrial control system 20 can be a partial system in a large control system. The industrial control system 20 can be a partial management system (for example, a building management system, factory management system, utility water management system, and electricity management system, etc.) that constitutes a system that manages the whole city.

Moreover, the industrial control system 20 can be a system that manages various devices (for example, telephone and copy machine etc.) connected to the network in an office or house. Further, the industrial control system 20 can be a system that manages multiple computers connected to the network in a corporate etc., or a system that manages a large number of servers connected to the network of a data center etc.

In the present embodiment, the industrial control system 20 includes multiple devices 22, a control apparatus 24, and a control network 26. Each of the multiple devices 22 is a various device included in the pertinent industrial control system 20. Each of the multiple devices 22 is, for an example, a device to be controlled in the pertinent industrial control system 20, a PLC (Programmable Logic Controller) that controls such devices, a sensor that detects the state of the device, etc., and an information processing apparatus such as a computer, etc.

The control apparatus 24 is implemented by a computer, etc. The control apparatus 24 controls each of the multiple devices 22, or acquires information from each of the multiple devices 22. The control network 26 interconnects between the control apparatus 24 and the multiple devices 22 and allows them to communicate information with each other. The control network 26 transfers data between the control apparatus 24 and each of the multiple devices 22 with a predetermined protocol such as the Internet Protocol.

The management system 30 manages the industrial control system 20. To be more specific, the management system 30 acquires a state of the industrial control system 20, and controls the pertinent industrial control system 20 depending on the acquired state. The management system 30 includes multiple firewall sections 32, a workflow database 34, a response database 36, an event analyzing section 38, and a communication managing section 40.

The industrial control system 20 includes multiple control zones 28 that are formed for controlling each part of the multiple devices 22. Each of the multiple firewall sections 32 is provided for each of the multiple control zones 28. Each of the multiple firewall sections 32 relays the communication between the devices 22 in the corresponding control zone 28 and the control network 26. The data that is inputted from the control apparatus 24 to each device 22 in the multiple control zones 28 via the control network 26, and the data that is outputted from each device 22 in the multiple control zones 28 to the control apparatus 24 via the control network 26 go by way of the corresponding firewall section 32.

Each of the multiple firewall sections 32 controls the communication between the devices 22 in the corresponding control zone 28 and the control network 26. For example, each of the multiple firewall sections 32 rewrites the content of the header of a message that is sent out from a particular device 22 to the control network 26, or discards the concerned message. Moreover, each of the multiple firewall sections 32 can limit the amount of communication, or change the communication route.

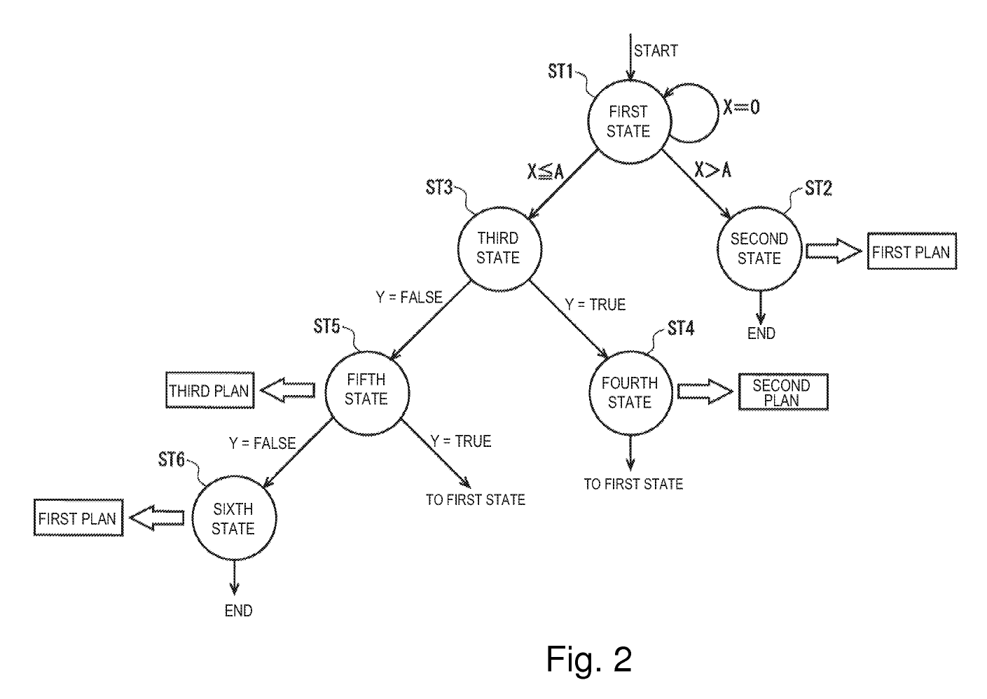

The workflow database 34 stores a state workflow that indicates a flow of the stage change of the industrial control system 20, an anomaly detection condition in each state indicated in the state workflow. The state workflow and the anomaly detection condition are created in advance by the manager of the management system 30, and registered on the workflow database 34. It is noted that the state workflow and the anomaly detection condition will be further described with reference to FIG. 2 and others.

The response database 36 stores a countermeasure flow that shows a countermeasure operation at the time of anomaly for the control zone, corresponding to each state indicated in the state workflow. The countermeasure flow is created in advance by the manager of the management system 30 and registered on the response database 36. It is noted that the countermeasure flow will be further described with reference to FIG. 2 and others.

The event analyzing section 38 collects and analyzes events from each of the multiple control zones to detect anomaly of each of the multiple control zones. In the present embodiment, the event analyzing section 38 collects and analyzes events from each of the multiple firewall sections 32 to detect an anomaly of each control zone 28.

Here, an event, which is a phenomenon that occurs in the industrial control system 20, refers to a phenomenon that can be detected by a sensor or a computer, etc. An event can be, for an example, a physical quantity (electric power, temperature, humidity, mass, volume and flow rate, etc.) that is detected by a sensor provided for a device etc. in the industrial control system 20. Moreover, an event can be a measurement value (for example, a data rate, a response for data transmission/reception, an error rate, etc.) of the data that is inputted and outputted to and from an information processing apparatus in the industrial control system 20. Furthermore, an event can be a state of each device (for example, the presence or absence of the connection of a switch and an operation mode of a device, etc.) in the industrial control system 20, or a state of a resource (for example, a data occupancy amount of memory and a usage rate of processor, etc.) that constitutes an information processing apparatus in the industrial control system 20.

The event analyzing section 38 manages the state of each of the multiple control zones 28 according to the state workflow. The event analyzing section 38 collects events for each of the multiple control zones 28 from the corresponding firewall section 32 via the management network 44. The event analyzing section 38 determines whether or not the collected events satisfy the anomaly detection condition in the current state determined by the state workflow stored in the workflow database 34, for each of the multiple control zones 28. Then, when it is determined that the anomaly detection condition is satisfied, the event analyzing section 38 determines that the state of the corresponding control zone has changed according to the state workflow. It is noted that the management of the state of the control zone 28 according to the state workflow will be further described with reference to FIG. 2 and others.

The communication managing section 40 changes the communication operation via the firewall section 32 provided in the control zone 28 where an anomaly has been detected. In response to determining that the state of the corresponding control zone 28 has changed, the communication managing section 40 applies a countermeasure flow that corresponds to the state after the change to the firewall section 32 for each of the multiple control zones 28.

The management network 44 interconnects the workflow database 34, the response database 36, the event analyzing section 38, and the communication managing section 40 with each other. The management network 44 is a network provided separately from the control network 26.

The management network 44 is connected with each of the multiple firewall sections 32. Each of the multiple firewall sections 32 includes a port for data input and output for interconnecting between the multiple devices 22 and the control network 26, and a port for control to be connected with the management network 44. Each of the multiple firewall sections 32 acquires events in the corresponding control zone 28, and provides the acquired events to the event analyzing section 38 via the management network 44. Also, each of the multiple firewall sections 32 controls the communication between the multiple devices 22 and the control network 26 according to a control instruction given from the communication managing section 40 via the management network 44.

FIG. 2 shows an example of a state workflow and anomaly detection condition. The workflow database 34 stores a state workflow represented by a state transition diagram as shown in FIG. 2. The event analyzing section 38 manages the state of each of the multiple control zones 28 based on the state transition diagram as shown in FIG. 2.

The event analyzing section 38 performs management with an assumption that the corresponding control zone 28 is in a first state (ST1), when the control zone 28 is normally operating. In the first state (ST1), the event analyzing section 38 acquires values of predetermined, specified type of sensors (for example, temperature sensors), which is provided in each of the multiple control zones 28, as events from the corresponding firewall section 32.

In the first state (ST1), the event analyzing section 38 determines that the corresponding control zone 28 is maintained in the first state (ST1), when error has not occurred in the collected values of the specified type of sensors (X=0). But, in the first state (ST1), the event analyzing section 38 determines that the corresponding control zone 28 has changed from the first state (ST1) to a second state (ST2), when error has occurred in the specified type of sensors, and the number of the sensors that have the error is larger than A (X>A). Further, in the first state (ST1), when error has occurred in the specified type of sensors, and the number of sensors that have the error is not more than A (X≦A), the event analyzing section 38 determines that the corresponding control zone 28 has changed from the first state (ST1) to a third state (ST3).

Here, the condition “error has occurred in the specified type of sensors, and the number of the sensors that have the error is larger than A” and the condition “error has occurred in the specified type of sensors, and the number of the sensors that have the error is not more than A” show the anomaly detection condition in the first state (ST1). The workflow database 34 stores such anomaly detection condition corresponding to the first state (ST1).

When a change from the first state (ST1) to the second state (ST2) has occurred, the communication managing section 40 executes a countermeasure flow, according to a first plan, for the corresponding control zone 28. The communication managing section 40 causes the corresponding control zone 28 to be shut down in a prescribed procedure to be executed as a first plan. The “first plan” is a countermeasure flow to be applied to the control zone 28, corresponding to the second state (ST2). The response database 36 stores such a countermeasure flow corresponding to the second state (ST2). Then, in the second state (ST2), the event analyzing section 38 determines that the operation of the corresponding control zone 28 has ended when the execution of the first plan has ended.

In the third state (ST3), the event analyzing section 38 acquires if the control network 26 is normally operating (for example, the degree of congestion of the control network 26) as events from the corresponding firewall section 32. When, as the result of collecting the events, the control network 26 is normally operating (Y=True) in the third state (ST3), the event analyzing section 38 determines that the corresponding control zone 28 has changed from the third state (ST3) to a fourth state (ST4). Moreover, when the control network 26 is not normally operating (Y=false) in the third state (ST3), the event analyzing section 38 determines that the corresponding control zone 28 has changed from the third state (ST3) to a fifth state (ST5).

Here, the condition “the control network 26 is normally operating” and the condition “the control network 26 is not normally operating” show the anomaly detection conditions in the third state (ST3). The workflow database 34 stores such anomaly detection condition corresponding to the third state (ST3).

When a change from the third state (ST3) to the fourth state (ST4) has occurred, the communication managing section 40 executes a countermeasure flow, according to the second plan, for the corresponding control zone 28. The communication managing section 40 causes the processing to invalidate the value of the sensor to be executed as the second plan. The value of the sensor has been determined to be abnormal among the specified type of sensors of the corresponding control zone 28. The “second plan” is a countermeasure flow to be applied to the control zone 28 corresponding to the fourth state (ST4). The response database 36 stores such countermeasure flow in correspondence with the fourth state (ST4). Then, the event analyzing section 38 determines that the corresponding control zone 28 has changed from the fourth state (ST4) to the first state (ST1) when the execution of the second plan has ended.

When a change from the third state (ST3) to the fifth state (ST5) has occurred, the communication managing section 40 executes a countermeasure flow, according to the third plan, for the corresponding control zone 28. The communication managing section 40 causes the processing to intercept the message from the sensor that has been determined to be abnormal heretofore among the specified type of sensors of the corresponding control zones 28 so as not to be transferred to the control network 26 to be executed as the third plan. The “third plan” is a countermeasure flow to be applied to the control zone 28 corresponding to the fifth state (ST5). The response database 36 stores such countermeasure flow in correspondence with the fifth state (ST5).

In the fifth state (ST5), the event analyzing section 38 acquires whether or not the control network 26 is normally working as events from the corresponding firewall section 32. When, as the result of collecting events, the control network 26 is normally operating (Y=True) in the fifth state (ST5), the event analyzing section 38 determines that the corresponding control zone 28 has changed from the fifth state (ST5) to the first state (ST1). Moreover, when the control network 26 is not normally operating (Y=False) in the fifth state (ST5), the event analyzing section 38 determines that the corresponding control zone 28 has changed from the fifth state (ST5) to a sixth state (ST6).

When a change from the fifth state (ST5) to the sixth state (ST6) has occurred, the communication managing section 40 executes a countermeasure flow, according to the first plan, for the corresponding control zone 28. The “first plan” is a countermeasure flow to be applied to the control zone 28 corresponding to the sixth state (ST6). The response database 36 stores such countermeasure flow in correspondence with the sixth state (ST6). Then, the event analyzing section 38 determines that the operation of the corresponding control zone 28 has ended when the execution of the first plan has ended in the sixth state (ST6).

According to the management system 30 relating to the present embodiment, it is possible to execute an appropriate countermeasure process of each state upon occurrence of anomaly. Further, according to the management system 30 relating to the present embodiment, since it controls the data to be communicated instead of directly controlling the devices 22 and computers. In the industrial control system 20, a countermeasure can be executed easily and quickly.

According to the management system 30 relating to the present embodiment, it is possible to reduce the influence of the countermeasure processing on anomaly since the control of communication is performed by providing a firewall section 32 for each of the multiple control zones 28. Furthermore, according to the management system 30 relating to the present embodiment, it is possible to improve safety and also improve security since the firewall section 32 is controlled via a dedicated management network 44. It is noted that the anomaly detection condition to be detected by the event analyzing section 38 and the plan to be executed by the communication managing section 40 can have the contents as described below.

The event analyzing section 38 detects whether or not an abnormal value is being transmitted from a first sensor which is a device 22 in the first control zone 28. Then, when it is detected that an abnormal value is being transmitted from a sensor in the first control zone 28, the communication managing section 40 can control the firewall section 32 provided in the first control zone 28 to intercept the transfer of the abnormal value to the control network 26. Thereby, the management system 30 can turn the operation of the control network 26 back to normal when an abnormal value of the first sensor continues to be detected due to a failure or the like. The communication of the control network 26 becomes to be not normally executed.

When it is detected that an abnormal value is being transmitted from the first sensor in the first control zone 28, the communication managing section 40 controls the firewall section 32 provided in the first control zone 28 to cause the pertinent firewall section 32 to transform an abnormal value into a normal value. This allows the management system 30 to reduce the influence of a failure of the first sensor on the outside.

When it is detected that an abnormal value is being transmitted from the first sensor in the first control zone 28, the communication managing section 40 can control the firewall section 32 provided in the second control zone 28 thereby causing the detected value by the second sensor in the second control zone 28 to be transferred to the control network 26 in place of the detected value by the first sensor. This allows the management system 30 to reduce the influence of the failure of the first sensor on the outside by using, as a substitute, the detected value by the second senor which serves as a backup of the first sensor.

The event analyzing section 38 detects whether or not the operation of the device 22 in the first control zone 28 is normal based on events collected from the firewall section 32 provided in the first control zone 28. When it is detected that the operation of a device 22 in the first control zone 28 is abnormal, the communication managing section 40 can control the firewall section 32 provided in the first control zone 28 to intercept a control signal to another control zone 28 from the pertinent device 22. As a result of this, for example when a sensor failed, the management system 30 can prohibit the result of the failed sensor from influencing other control zones 28.

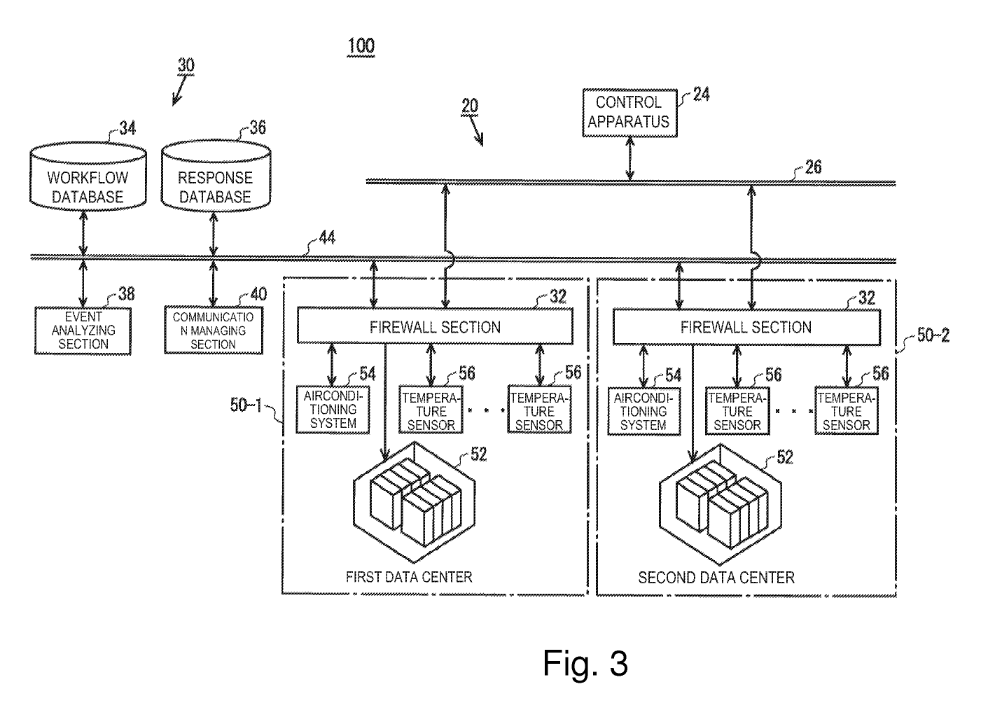

FIG. 3 shows the configuration of a data center system 100 relating to a variant of the present embodiment. The present embodiment can be applied to a data center system 100. The data center system 100 includes substantially the same function and configuration as those of the computing system 10 shown in FIG. 1. The components having the same configuration and the same function are given the same names and reference symbols and the description will be omitted except differing points.

The data center system 100 includes a first data center 50-1 and a second data center 50-2. Each of the first data center 50-1 and the second data center 50-2 corresponds to control zones 28 shown in FIG. 1. The first data center 50-1 and the second data center 50-2 are set up in different cities (for example, one in Tokyo and the other in Osaka) and are configured to back up each other upon occurrence of malfunction.

Each data center 50 includes, for an example, a computer zone 52, an air conditioning system 54, and multiple temperature sensors 56. The computer zone 52 is provided with a server. The air conditioning system 54 adjusts the temperature of the room in which the server is provided in response to temperature values detected by the multiple temperature sensors 56. The multiple temperature sensors 56 measure the temperature of the server. Each of the computer zone 52, the air conditioning system 54, and the multiple temperature sensors 56 corresponds to the device 22 shown in FIG. 1.

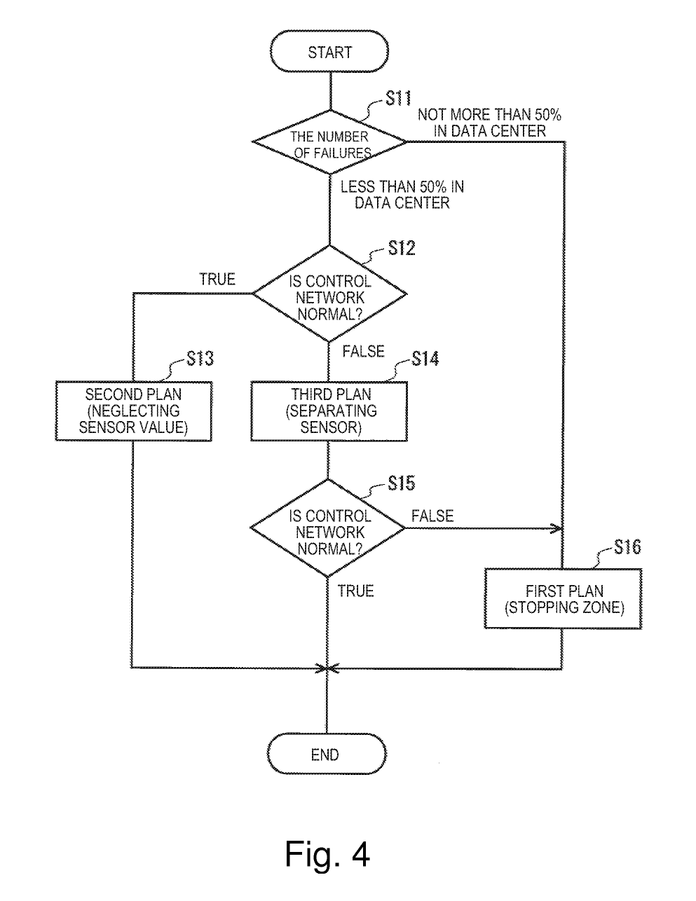

FIG. 4 shows an example of the process flow at the time of temperature anomaly of the data center system 100. First, the event analyzing section 38 acquires temperatures detected by each of the multiple temperature sensors 56 as events for each data center 50 at a normal temperature. The event analyzing section 38 determines that each of the multiple temperature sensors 56 is normally operating if the temperatures detected by each of the multiple temperature sensors 56 are in a normal temperature range.

The event analyzing section 38 acquires temperatures (events), for example, in each fixed period of time, and advances the process to step S11 if the temperature sensor 56 fails (for example, when a detected temperature indicates a maximum value or minimum value of the temperature range) in any data center 50.

In step S11, the event analyzing section 38 determines whether or not 50% or more of all the temperature sensors 56 in the data center 50 have failed. The event analyzing section 38 advances the process to step S16 when 50% or more of all the temperature sensors 56 in the data center 50 have failed. The event analyzing section 38 advances the process to step S12 when less than 50% of all the temperature sensors 56 in the data center 50 have failed.

In step S12, the event analyzing section 38 determines whether or not the control network 26 is normally operating. The event analyzing section 38 advances the process to step S13 when the control network 26 is normally operating (True of S12). The event analyzing section 38 advances the process to S14 when the control network 26 is not normally operating (False of S12).

In step S13, the communication managing section 40 causes a countermeasure flow corresponding to the second plan to be executed. The communication managing section 40 causes, for an example, the firewall section 32 of the data center 50 to execute the processing to invalidate the value of the failed temperature sensor 56 (for example, processing to replace the temperature value outputted from the failed temperature sensor 56 with an invalid value) as the second plan. As a result, the communication managing section 40 can appropriately adjust the temperature of the room in which a server is provided, since erroneous temperature control according to temperature values detected by the failed temperature sensor 56 will be prohibited. Upon completing the processing of step S13, the event analyzing section 38 gets out of the pertinent flow, and maintains the operation as a normal state until a new failed temperature sensor 56 is detected next.

In step S14, the communication managing section 40 causes a countermeasure flow corresponding to the third plan to be executed. The communication managing section 40 causes, for an example, the firewall section 32 of the data center 50 to execute the processing to intercept the transfer of the value of the failed temperature sensor 56 (for example, the processing to discard temperature values outputted from the failed temperature sensor 56) as the third plan. As a result, the communication managing section 40 can appropriately adjust the temperature of the room in which a server is provided, and stabilize the process of the entire data center system 100 concerned, since erroneous temperature control according to temperature values detected by the failed temperature sensor 56 will be prohibited, and moreover congestion of the network will be eliminated.

After completion of the processing of step S14, the event analyzing section 38 advances the process to step S15. In step S15, the event analyzing section 38 determines whether or not the control network 26 is normally operating. When the control network 26 is normally operating (True of S15), the event analyzing section 38 gets out of the pertinent flow and maintains the operation as a normal state until a new failed temperature sensor 56 is detected next. When the control network 26 is not normally operating (False of S15), the event analyzing section 38 advances the process to step S16.

In step S16, the communication managing section 40 causes a countermeasure flow corresponding to the first plan to be executed. The communication managing section 40 causes the processing to move a service provided by the data center 50 to another data center 50 thereby stopping the data center 50, as the first plan. As a result of this, when the number of failed temperature sensors 56 is large and there is a possibility that temperature control of the data center 50 cannot be stably performed, the communication managing section 40 can stop the data center 50 without influencing the users of the data center 50. Then, having completed the processing of step S16, the communication managing section 40 gets out of the pertinent flow and ends the control for the data center 50.

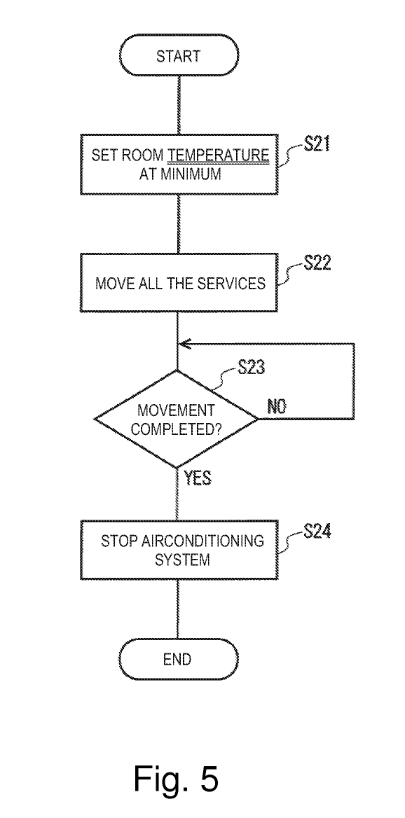

FIG. 5 shows an example of a countermeasure flow in the data center system 100. The communication managing section 40 executes, for example, the countermeasure flow shown in FIG. 5 as the first plan to be executed in step S16. In step S21, the communication managing section 40 controls the air conditioning system 54 in the corresponding data center 50 via the firewall section 32 of the corresponding data center 50 to set the room temperature at minimum. As a result of this, the communication managing section 40 can at least avoid breakage of devices due to abnormal temperature rise.

In step S22, the communication managing section 40 gives an instruction to the control apparatus 24 via the firewall section 32 of the corresponding data center 50 to move all the services provided by the corresponding data center 50 to the other data center 50. That is, if an anomaly has occurred in the first data center 50-1, all the services provided by the first data center 50-1 are moved to the second data center 50-2.

Next, in step S23, the communication managing section 40 stands ready for processing until the moving process is completed. When all the services are moved (Yes in step S23), the communication managing section 40 advances the process to step S24. In step S24, the communication managing section 40 stops the operation of the air conditioning system 54 of the corresponding data center 50. As described so far, the communication managing section 40 can stop the data center 50 without influencing the users of the data center 50. According to the computing system 10 relating to the present embodiment, it is possible to execute an appropriate countermeasure for the data center 50 in response to the level of failure at the time of failure of the temperature sensor 56.

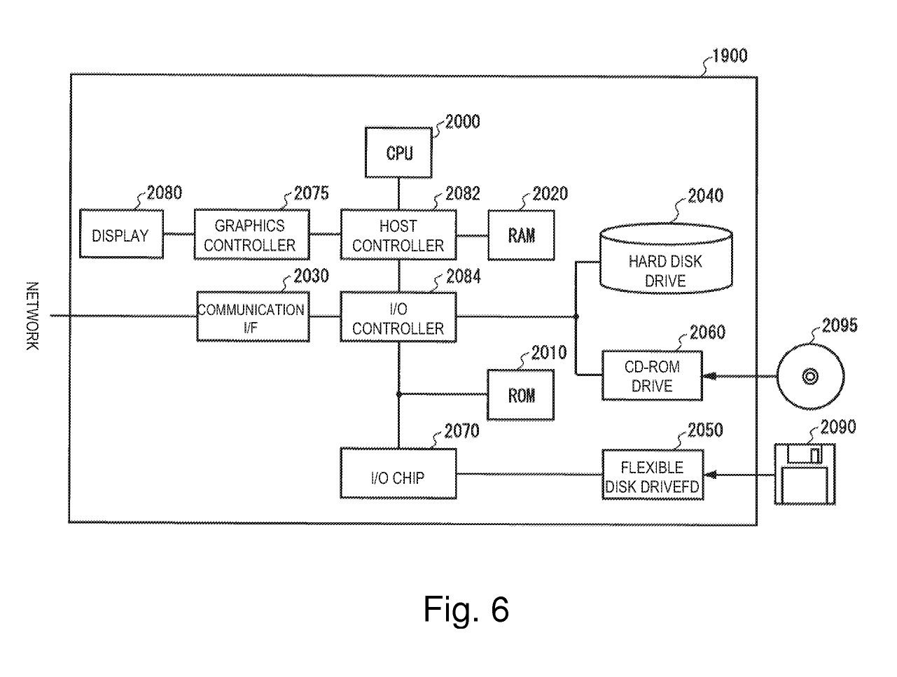

FIG. 6 shows an example of the hardware configuration of a computer 1900 relating to the present embodiment. The computer 1900 relating to the present embodiment includes: a CPU peripheral section having a CPU 2000, a RAM 2020, a graphic controller 2075, and a display apparatus 2080, which are interconnected with each other by a host controller 2082; an I/O section having a communication interface 2030, a hard disk drive 2040, and a CD-ROM drive 2060, which are connected to the host controller 2082 by an I/O controller 2084; and a legacy I/O section having a ROM 2010, a flexible disk drive 2050, and an I/O chip 2070, which are connected to the I/O controller 2084.

The host controller 2082 connects the RAM 2020 with the CPU 2000 and the graphic controller 2075 which access the RAM 2020 at a high transfer rate. The CPU 2000 operates based on a program stored in the ROM 2010 and the RAM 2020 to control each section. The graphic controller 2075 acquires image data created by the CPU 2000 etc. on a frame buffer provided in the RAM 2020 and displays them on the display apparatus 2080. In place of this, the graphic controller 2075 can incorporate a frame buffer for storing image data created by the CPU 2000 and others.

The I/O controller 2084 connects the host controller 2082 with the communication interface 2030, the hard disk drive 2040, and the CD-ROM drive 2060, which are I/O apparatuses having a relatively high speed. The communication interface 2030 communicates with other apparatuses via the network. The hard disk drive 2040 stores programs and data which are used by the CPU 2000 in the computer 1900. The CD-ROM drive 2060 reads out a program or data from the CD-ROM 2095 and provides the same to the hard disk drive 2040 via the RAM 2020.

Moreover, the I/O controller 2084 is connected with the ROM 2010, the flexible disk drive 2050, and the I/O chip 2070, which are I/O apparatuses having a relatively low speed. The ROM 2010 stores a boot program which is executed at the time of activation of the computer 1900, and/or programs that depend on the hardware of the computer 1900, etc. The flexible disk drive 2050 reads out a program or data from a flexible disk 2090, and provides the same to the hard disk drive 2040 via the RAM 2020. The I/O chip 2070 connects the flexible disk drive 2050 to the I/O controller 2084, as well as connects various I/O apparatuses to the I/O controller 2084 via, for example, a parallel port, a serial port, a keyboard port, a mouse port, and the like.

A program which is provided to the hard disk drive 2040 via the RAM 2020 is provided by the user in a state of being stored in a recording medium such as the flexible disk 2090, the CD-ROM 2095, or an IC card, etc. The program is read out from the recording medium, and is installed on the hard disk drive 2040 in the computer 1900 via the RAM 2020, thereafter being executed at the CPU 2000.

Programs which are installed in the computer 1900 and instruct the computer 1900 to function as a management system 30 include a workflow database module, a response database module, an event analyzing module, and a communication management module. These programs or modules act on the CPU 2000 or the like and instruct the computer 1900 to function as the workflow database 34, the response database 36, the event analyzing section 38, and the communication managing section 40, respectively.

The information processing described in these programs are read into the computer 1900, and thereby function as the workflow database 34, the response database 36, the event analyzing section 38, and the communication managing section 40, which are practical means in which software and the above-described various hardware resources cooperate. Then, by implementing computation or modification of information according to purposes of the use of the computing system 10 in the present embodiment by these practical means, a unique management system 30 according to the purpose of use is constructed.

As an example, when communication is performed between the computer 1900 and external apparatuses, the CPU 2000 executes a communication program loaded onto the RAM 2020, and gives instruction of communication processing to the communication interface 2030 based on the processing content described in the communication program. The communication interface 2030 is controlled by the CPU 2000 to read out transmission data stored in a transmission buffer region provided on a storage apparatus such as the RAM 2020, the hard disk drive 2040, the flexible disk 2090, or the CD-ROM 2095 and transmits them to the network, or writes reception data received from the network to a reception buffer region provided on a storage apparatus. In this way, the communication interface 2030 can transfer the transmission/reception data to and from the storage apparatus by a DMA (Direct Memory Access) scheme, or as an alternative to this, the CPU 2000 can read out the data from the storage apparatus of transfer source or the communication interface 2030, and transfers the transmission/reception data by writing the data to the communication interface 2030 or a storage apparatus of transfer destination.

Moreover, the CPU 2000 causes all or necessary part of the file or database stored in an external storage apparatus such as the hard disk drive 2040, the CD-ROM drive 2060 (CD-ROM 2095), the flexible disk drive 2050 (flexible disk 2090), and the like to be read into the RAM 2020 by the DMA transfer or the like, and performs various processing on the data on the RAM 2020. Then, the CPU 2000 rewrites the processed data in the external storage apparatus by the DMA transfer or the like. In such processing, since the RAM 2020 can be regarded as one that temporarily retains the content of the external storage apparatus, the RAM 2020 and the external storage apparatus are generally referred to as a memory, a storage section, or a storage apparatus in the present embodiment.

Various kinds of information such as various programs, data, tables, or databases in the present embodiment are stored on such storage apparatuses and is subject to information processing. It is noted that the CPU 2000 can retain a part of the RAM 2020 in a cache memory and perform read and write operations on the cache memory. Even in such a form, since the cache memory bears part of the function of the RAM 2020, it is supposed in the present embodiment that the cache memory is also included in the RAM 2020, the memory, and/or the storage apparatus excepting the case when it is distinctively referred.

The CPU 2000 performs various processing specified by an instruction sequence of the program, including various computation, modification of information, conditional judgment, search-and-replace of information etc., which are described in the present embodiment, on the data read out from the RAM 2020, and writes them back to the RAM 2020. For example, when performing conditional judgment, the CPU 2000 determines if one of the various variables is different in value than another variable or if the constant is satisfied. When the condition is effected (or is failed), the process is branched off to a different instruction sequence, or calls a sub routine.

The CPU 2000 can search information stored in, for example, a file or data base in the storage apparatus. For example, in a case where multiple entries, in which attribute values of a second attribute are put into correspondence to attribute values of a first attribute, are stored in a storage apparatus, the CPU 2000 can obtain an attribute value of the second attribute which is put into correspondence to the first attribute that satisfies a predetermined condition, by searching an entry that corresponds to the condition by which the attribute value of the first attribute is specified from the multiple entries stored in the storage apparatus, and reading out the attribute value of the second attribute stored in the entry.

The programs or modules shown so far can be stored in an external storage medium. As a recording medium, one can use optical recording media such as DVDs or CDs etc., magneto-optic recording media such as MOs etc., tape media, and semiconductor memories such as IC cards etc., as well as the flexible disk 2090 and the CD-ROM 2095. Moreover, storage apparatus such as a hard disk, a RAM, etc., are provided in a server system that is connected to a dedicated communication network or the Internet can be used as a recording medium, thereby providing the program to the computer 1900 via the network.

Though the present invention has been described using embodiments so far, the technical scope of the present invention will not be limited to the range according to the above described embodiments. It would be obvious to those skilled in the art that various modifications and improvements could be made to the above described embodiments without departing from the claims of the invention. From the statements of the patent claims, it is clear that embodiments with such modifications and improvements are also included in the technical scope of the present invention.

It is noted that the order of executing each processing, such as operations, procedures, steps, and stages in the apparatus, system, program, and method shown in the claims, description, and drawings can be implemented in an arbitrary order as long as it is not explicitly stated as, such as “before”, “prior to”, etc., or unless the output of preceding processing is used in the subsequent processing. Regarding operational flows in the claims, description, and drawings, even if they are explained by conveniently using terms, such as “first” and “next” etc., this will not mean that performing in this order is a necessity.

We claim:

1. A management system for an industrial control system comprising a control apparatus, a control network connected to the control apparatus, and multiple devices controlled by the control apparatus via the control network, the management system comprising:
multiple firewall modules provided for each of control zones each controlling one part of the industrial control system, the firewall modules relaying communication between devices in the control zones and the control network;
an event analyzing module collecting events from each of the multiple firewall modules and analyzing the events to detect an anomaly of each of the control zones; and
a communication managing module changing a communication operation performed via the firewall module provided for the control zone where an anomaly has been detected.

2. The management system according to claim 1, further comprising:
a workflow database storing a state workflow that indicates a flow of state change of the industrial control system, and an anomaly detection condition in each state indicated in the state workflow; and
a response database storing a countermeasure flow for the control zone, the countermeasure flow corresponding to each state indicated in the state workflow, wherein the event analyzing module determines whether or not collected events satisfy an anomaly detection condition in a current state determined by the state workflow, for each of multiple control zones, and in response to determining that the state of the corresponding control zone has changed, applies the countermeasure flow corresponding to the state after change to the firewall module for each of the multiple control zones.

3. The management system according to claim 1, wherein the event analyzing module detects whether or not an abnormal value is being transmitted from a first sensor which is a device in a first of the control zones, and in response to detecting that an abnormal value is being transmitted from the sensor in the first control zone, the communication managing module controls the firewall module provided in the first control zone to intercept transfer of the abnormal value to the control network.

4. The management system according to claim 2, wherein the event analyzing module detects whether or not an abnormal value is being transmitted from a first sensor which is a device in a first of the control zones, and in response to detecting that an abnormal value is being transmitted from the sensor in the first control zone, the communication managing module controls the firewall module provided in the first control zone to intercept transfer of the abnormal value to the control network.

5. The management system according to claim 1, wherein, in response to detecting that an abnormal value is being transmitted from the first sensor in a first of the control zones, the communication managing module controls the firewall module provided in a second of the control zones to cause a detected value by a second sensor in the second control zone to be transferred to the control network, in place of the detected value by the first sensor.

6. The management system according to claim 1, wherein in response to detecting that an abnormal value is being transmitted from the first sensor in a first of the control zones, the communication managing module controls the firewall module provided in the first control zone to cause the firewall module to transform the abnormal value to a normal value.

7. The management system according to claim 1, wherein the event analyzing module:
(i) based on events collected from the firewall module provided in the first control zone, detects whether the operation of a device in a first of the control zones is normal; and
(ii) in response to detecting that the operation of the device in the first control zone is abnormal, controls the firewall module provided in the first control zone to intercept a control signal from the device to another of the control zones.

8. The management system according to claim 1, further comprising:
a management network interconnecting the multiple firewall modules, the event analyzing module, and the communication managing module.

9. An industrial control system, comprising:
a control apparatus;
a control network connected to the control apparatus;
multiple devices that are controlled by the control apparatus via the control network;
multiple firewall modules provided for each of control zones including each part of the multiple devices, the multiple firewall modules relaying the communication between the devices in the control zones and the control network;
an event analyzing module collecting events that occur in the multiple firewall modules and analyzing the events to detect an anomaly of each of the control zones; and
a communication managing module changing communication operation via a firewall module provided in the control zone where an anomaly has been detected.

10. A management method for managing an industrial control system including a control apparatus, a control network connected to the control apparatus, multiple devices controlled by the control apparatus via the control network, and multiple firewall modules provided for each of control zones that controls each part of the multiple devices, the method comprising:
relaying the communication between the devices in the control zones and the control network by the multiple firewall modules;
collecting events that occur in the multiple firewalls and analyzing the events to detect an anomaly of each of the control zones, by a computer; and
changing the communication operation via the firewall module provided in the control zone where an anomaly has been detected, by the computer.

11. A non-transitory computer readable storage medium tangibly embodying a computer readable program code having computer readable instructions which, when implemented, cause a computer to carry out the steps of a method of managing an industrial control system comprising a control apparatus, a control network connected to the control apparatus, multiple devices controlled by the control apparatus via the control network, and multiple firewall modules provided for each of control zones for controlling each part of the multiple devices, the firewall modules relaying the communication between the devices in the control zones and the control network, wherein the method comprises the steps of claim 10.
